(19) United States
(12) Patent Application Publication
(10) Pub. No.: US 2010/0102650 A1
(43) Pub. Date: Apr. 29, 2010

(54) Arrangement for cooling of an electrical machine

(76) Inventors: Uffe Eriksen, Horsens (DK); Henrik Stiesdal, Odense C (DK)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/606,209

(22) Filed: Oct. 27, 2009

(30) Foreign Application Priority Data
Oct. 28, 2008 (EP) 08018802.2

(51) Int. Cl. H02K 9/19; H02K 9/00

(52) U.S. Cl. 310/54; 310/64

(57) ABSTRACT

In one aspect, an arrangement is provided. An electrical machine includes elements generating heat while the electrical machine is at work. The elements include at least one fixing-arrangement to support an element-structure. The fixing-arrangement is hollow to carry a cooling fluid which allows a transfer of the heat away from the elements.

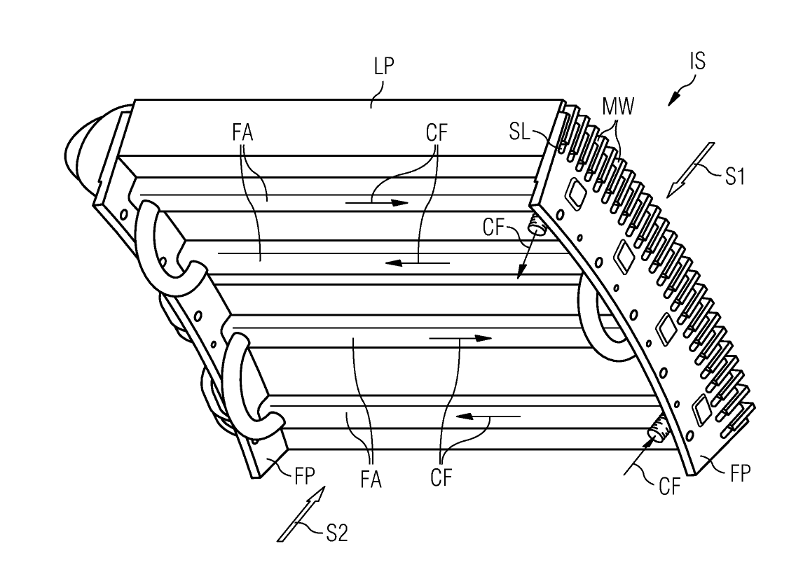

### CROSS REFERENCE TO RELATED APPLICATIONS

This application claims priority of European Patent Office application No. 08018802.2 EP filed Oct. 28, 2008, which is incorporated by reference herein in its entirety.

### FIELD OF INVENTION

The invention relates to an arrangement for cooling of an electrical machine.

### BACKGROUND OF INVENTION

In a preferred embodiment it relates to the cooling of an electrical machine which, is totally enclosed by a shell or housing.

Electrical machines need cooling in order to dissipate the heat, which is generated during operation by ohmic resistance, iron hysteresis, etc.

Small electrical machines may be “surface cooled”, but due to the fact that large machines have relatively smaller surfaces per power rating and heat generation, this arrangement will not work for large machines

When installed under indoor conditions in a normal, dry atmosphere, electrical machines may be not enclosed by a housing, so the cooling can be done by the circulation of ambient air through the machine.

However, when installed under harsh conditions, e.g. as generators in offshore wind-turbines, electrical machines need to be totally enclosed and ambient air may not be allowed to circulate through the machine.

Hence, a dedicated cooling system is required.

### SUMMARY OF INVENTION

One very common method for cooling is the circulation of air or another gaseous medium inside the electrical machine. This air or other gaseous medium is kept cool, for example by use of a heat exchanger.

This cooling method has the disadvantage, that large gas-to-air or gas-to-water heat exchangers are required. Furthermore considerable power is required to circulate the cooling medium.

Another very common cooling method for generators is the circulation of a liquid coolant on a first side of a stator of the generator. This first side is not facing to an air gap, which is between the stator and the rotor.

The stator shows laminate plates, which carries a number of stator-coils, to produce magnetic-fields. The coils are built by metallic-windings. So heat, which is generated at the metallic-windings, is transferred from the metallic-windings through the laminate plates to the cooling medium by conduction.

This cooling method has the disadvantage that it may be difficult to ensure good thermal contact between the stator laminate plates and channels, which are used for the flow of a coolant liquid.

In particular, due to differences in thermal expansion between the stator laminate and the cooling-structure small air gaps may occur between the stator laminate and the coolant channels at certain temperature levels.

Due to the good insulating properties of air such small air gaps are detrimental to the efficiency of the cooling.

Furthermore, the need for substantial cooling structures, such as metallic channels, in addition to the normal structure used to support and maintain geometry and stability of the stator laminate, will typically lead to an increase in liquid cooled machine weight over and above the weight of an air cooled machine.

It is aim of the present invention, to provide an improved cooling arrangement for an electrical machine as described above.

This aim is solved by the features of the independent claims.

Advantageous embodiments of the invention are described within the subsequent claims.

The inventive arrangement for cooling consists of an electrical machine, where the electrical machine shows elements (LP), which generates heat while the electrical machine is at work. The elements (LP) show at least one fixing-arrangement (FA) to support an element-structure. The fixing-arrangement (FA) is hollow to carry a cooling fluid (CF) which allows a transfer of the heat away from the elements (LP).

According to the invention is a combined use of fixing-arrangements, so they support a structure on one hand and they are used as coolant-channels on the other hand.

The inventive step lies in the combination of coolant channels and support structure, which ensures both low weight and good thermal contact.

### BRIEF DESCRIPTION OF THE DRAWINGS

The invention will be described in more detail by help of a FIGURE.

The FIGURE shows the inventive cooling-arrangement for a generator, which is used within an offshore wind-turbine for example.

### DETAILED DESCRIPTION OF INVENTION

That kind of generator is normally totally enclosed by a shell or by a housing to avoid the influence of harsh ambient conditions to components of the generator.

The generator in this example shows an inner stator and an outer rotor, while there is a gap with air between them.

The inner stator IS, which is shown here partly, consists of a number of laminate plates LP made of metal.

The laminate plates LP show on a first side Si a number of slots SL, so the slots SL are forming a number of channels on the first side S1.

Within the slots SL there are metal windings MW, which are used to build electrical coils of the inner stator IS. Shown here is a so called “single-layer winding” with one metal-winding per slot SL.

Next to the metal-windings MW there is the air-gap, while the outer rotor—not shown here—interacts with the metal windings MW of the inner stator IS.

On a second side S2 of the laminate plates LP there are a number of fixing-arrangements FA, which are used to support the structure of the laminate plates LP and of the stator IS, too.

The fixing-arrangement FA are connected, to allow the circulation of a cooling fluid CF, which is brought within the fixing arrangement FA.

In a preferred embodiment water is used as cooling fluid CF, where water may be used together with glycol.

With help of the fixing-arrangements FA generated heat is transferred away from the stator IS, so the connected fixing-arrangements FA are part of a cooling-system.

In a preferred embodiment the heat is transferred to ambient by a cooling fluid CF, where it is cooled by help of a liquid-to-air heat-exchanger.

In a preferred embodiment the fixing-arrangements FA are made of metal pipes. This allows long-term-stability of the cooling-system and of the supported structure.

The laminate plates LP are compressed by finger-plates FP at both ends. These finger-plates FP are fixed to the metal pipes, so they jointly form a support structure, which is integrated with the laminate plates LP.

Cavities of the metal pipes foil a the coolant-channels. During machine operation the coolant fluid is made to flow through the pipes.

In a preferred embodiment the fixing-arrangements FA are connected by glue or by welding with the laminate plates LP, to avoid tiny air-gaps between the structures, which might influence the heat-transfer from the laminate plates LP to the cooling-system.

This inventive arrangement has the following advantages:
an efficient cooling can be ensured due to the continuous maintenance of a direct heat transfer contact between coolant channels and the stator laminate plates;
since the coolant channels doubles as support structure, weight increase relative to an air cooled machine can be avoided; and
the cooling system can be made more simple, robust and low-cost than other known liquid cooling systems.

1.-10. (canceled)

11. An arrangement for cooling of an electrical machine, wherein
the electrical machine includes an element that generates heat while the electrical machine is at work, and
the element includes a hollow fixing-arrangement supports an element-structure and includes a cooling fluid to transfer heat away from the element.

12. The arrangement according to claim 11, wherein the cooling fluid is water.

13. The arrangement according to claim 11, wherein the cooling fluid includes water.

14. The arrangement according to claim 11, wherein the electrical machine is totally enclosed by a shell or by a housing to avoid an influence of harsh ambient conditions to components of the electrical machine.

15. The arrangement according to claim 11, wherein a plurality of fixing-arrangements are connected, to allow the circulation of the cooling fluid within the fixing arrangements.

16. The arrangement according to claim 11, wherein the fixing-arrangement forms a part of a cooling-system.

17. The arrangement according to claim 11, wherein the fixing-arrangement is a metal pipe.

18. The arrangement according to claim 17, wherein the metal pipe is filled with the cooling fluid.

19. The arrangement according to claim 11, wherein the fixing-arrangement is connected to the heating element by glue or by welding.

20. The arrangement according to claim 11, wherein the electrical machine is a generator.

21. The arrangement according to claim 11, wherein the generator is located within a nacelle of a wind-turbine.

22. The arrangement according to claim 20, wherein,
the generator includes a stator that includes a plurality of laminate plates as heat elements;
the laminate plates includes a plurality of stator coils arranged on a first side to interact with a rotor of the generator, and
the fixing-arrangement is located at a second side, which is opposite to the first side.

23. A generator, comprising:
an element that generates heat while the generator is at work,
wherein the element includes a hollow fixing-arrangement that supports an element-structure and that carries a cooling fluid in order to transfer heat away from the element.

24. The generator according to claim 23, wherein the cooling fluid includes water.

25. The generator according to claim 23, wherein the electrical machine is totally enclosed by a shell or by a housing to avoid an influence of harsh ambient conditions to components of the electrical machine.

26. The generator according to claim 23, wherein a plurality of fixing-arrangements are connected, to allow the circulation of the cooling fluid within the fixing arrangements.

27. The generator according to claim 23, wherein the fixing-arrangement is a metal pipe.

28. The generator according to claim 27, wherein the metal pipe is filled with the cooling fluid.

29. The generator according to claim 23, wherein the fixing-arrangement is connected to the heating element by glue or by welding.

30. The generator according to claim 29, further comprises
a rotor; and
a stator that includes a plurality of laminate plates as heat elements,
wherein the laminate plates includes a plurality of stator coils arranged on a first side to interact with the rotor, and
wherein the fixing-arrangement is located at a second side, which is opposite to the first side.
